(19) United States
(12) Patent Application Publication
(10) Pub. No.: US 2011/0131903 A1
(43) Pub. Date: Jun. 9, 2011

(54) MUNTIN CLIP

(76) Inventor: Stefan Ifko, Woodbridge (CA)

(21) Appl. No.: 12/948,497

(22) Filed: Nov. 17, 2010

Related U.S. Application Data
(60) Provisional application No. 61/261,968, filed on Nov. 17, 2009.

(51) Int. Cl. E06B 3/54

(52) U.S. Cl. 52/204.61

(57) ABSTRACT

A muntin clip comprises a base having an interior face and an opposed exterior face. The interior and exterior faces extend between a first end positionable towards the first glazing pane and a second end positionable towards the second glazing pane. A muntin connector extends from the interior face. The muntin connector comprises a tongue receivable within the muntin bar and frictionally securable therein. A seal connector extends from the exterior face. The seal connector comprises a side plate positionable between the seal and the first glazing pane. The side plate has an inner face positionable to face the seal and an opposed outer face. At least one tooth extends from the inner face. The at least one tooth is insertable into the seal.

This application claims the benefit of Provisional Application No. 61/261,968, filed Nov. 17, 2009, which is hereby incorporated herein by reference.

### FIELD

The disclosure relates to window units, and more particularly, to one or more methods or apparatuses associated with securing a muntin between first and second glazing panes of a window glazing unit.

### INTRODUCTION

U.S. Pat. No. 7,568,317 (Longden) discloses a glazing clip for fitting about the edge of a glazing unit. The glazing clip comprises means for interengaging with an ancillary element on at least one side of a glazing unit, in use.

U.S. Pat. No. 7,533,507 (Hornung et al.) discloses techniques for mounting simulated muntin bars, preassembled muntin grids and the like between parallel glazing sheets in an integrated multipane window sash. Among the mounting techniques disclosed are clips for holding simulated muntin components to a spacing and mounting structure of an integrated multipane window sash. Clip-less embodiments are also presented, as well as a one-piece sash that includes integral muntins and an integral spacing and mounting structure for the glazing sheets.

U.S. Pat. No. 6,974,518 (Hornung et al.) discloses a window sash frame with a glazing pane installation opening accessible from a first side thereof and a glazing pane support surface on a second side thereof. A first glazing pane is inserted into the installation opening and an outside surface perimeter of the pane is placed adjacent to the support surface. A second glazing pane is then inserted into the opening. An inside surface perimeter of the second pane is mounted (e.g., via an adhesive bead, strip, tape or foam) to an inside surface perimeter of the first glazing pane. The adhesive thickness is such that the panes are separated by a space, which can contain air or an inert insulating gas. A glazing bead is installed along at least a portion of the glazing pane installation opening after the glazing panes have been inserted. A spacer can alternatively or additionally be provided between the glazing panes.

U.S. Pat. No. 6,494,002 (Gieseke) discloses a muntin bar clip to secure the position of muntin bars during and following the fabrication of multi-pane sealed glass window units, and a method of securing and positioning muntin bars at multi-pane sealed glass window unit perimeters and in joining hollow false muntin bars within such units. Muntin bar clips fix the position of hollow false muntin bars at the perimeter of the window unit utilizing the sealing methods including foam strips and or butyl as the sealing medium. Muntin bar clips fix the position of hollow false muntin bars at the perimeter of the window unit where the false muntin bar is other than orthogonal in relation to the perimeter of the window. The position of muntin bars are fixed by securing the muntin bar clips by forming at a muntin bar clip tip end one or a plurality of spikes wherein the penetration, of one or a plurality of spikes, into the material of the sealing and or spacing method employed secures the position of the muntin bar. The apparatus lessens the likelihood of either breaking or cracking the glass panes, as multi-pane sealed unit assembly occurs, or of causing seal failure of such units either during manufacture or following installation and increases the likelihood of securing the muntin bars into permanent position.

### SUMMARY

The following summary is provided to introduce the reader to the more detailed discussion to follow. The summary is not intended to limit or define the claims.

According to one aspect, a window glazing unit is provided. The window glazing unit comprises a first glazing pane and a second glazing pane in parallel and opposed relation to the first glazing pane. The first and second glazing panes are spaced apart by a glazing gap. A seal is disposed between the first and second glazing panes about the periphery thereof. The seal has a seal height equal to the glazing gap and a seal width transverse to the height. At least one generally hollow muntin is provided between the first glazing pane and the second glazing pane. The muntin has at least one end adjacent the seal. A muntin clip secures the end of the muntin in a fixed position to the seal. The muntin clip comprises a base having an interior face and an opposed exterior face. The interior and exterior faces extend between a base first end positioned towards the first glazing pane and a base second end positioned towards the second glazing pane. The base has a base height defined between the base first end and the base second end. The base height is substantially equal to the glazing gap. A muntin connector extends from the interior face. The muntin connector comprises a tongue received within the end of the muntin and frictionally secured therein. A seal connector extends from the exterior face. The seal connector comprises a side plate positioned between the seal and the first glazing pane. The side plate has an inner face facing the seal and an opposed outer face. At least one tooth extends from the inner face and is inserted into the seal.

The base, muntin connector, and seal connector may be integrally formed by injection molding of a plastic.

The inner face and the outer face extend between a side plate first end adjacent the base and an opposed side plate second end and may define a side plate width between the side plate first end and the side plate second end. The side plate width may be substantially equal to the seal width.

The at least one tooth may be spaced from the side plate first end and side plate second end. The at least one tooth may comprise two teeth.

The side plate second end may comprise an indicator for aligning with a mating indicator on a window frame within which the window glazing unit is received. The indicator may be a notch extending inwardly into the side plate from the side plate second end.

The tongue may comprise an arm extending orthogonally from the base, and a plurality of resiliently flexible wings extending outwardly from the arm and frictionally engaging the muntin. The arm may comprise a foot adjacent the base, a body portion extending from the foot, and a distal end portion adjacent the body portion. The plurality of wings may extend from body portion, and may be angled towards the foot. The arm may be generally rectangular in transverse cross section, and the plurality of wings may comprise a first set of wings extending from a first side of the arm and a second set of wings extending from an opposed second side of the arm. The distal end portion may comprise a bevel. The foot may frictionally engage the muntin. The body portion may have a cross sectional area less than the cross sectional area of the foot. The tongue may be spaced from the first end and the second end of the base.

According to another aspect, a window glazing unit is provided. The window glazing unit comprises a first glazing pane and a second glazing pane in parallel and opposed relation to the first glazing pane. The first and second glazing panes are spaced apart by a glazing gap. A seal is disposed between the first and second glazing panes about the periphery thereof. The seal has a seal height equal to the glazing gap and a seal width transverse to the seal height. At least one generally hollow muntin is provided between the first glazing pane and the second glazing pane. The muntin has at least one end adjacent the seal. A muntin clip secures the end of the muntin in a fixed position to the seal. The muntin clip comprises a base having an interior face and an opposed exterior face. The interior and exterior faces extend between a base first end positioned towards the first glazing pane and a base second end positioned towards the second glazing pane. A muntin connector extends from the interior face. The muntin connector comprises a tongue received within the end of the muntin and frictionally secured therein. A seal connector extends from the exterior face. The seal connector comprises a side plate positioned between the seal and the first glazing pane. The side plate has an inner face facing the seal and an opposed outer face. The inner face and the outer face extend between a side plate first end adjacent the base and an opposed side plate second end, and define a side plate width between the side plate first end and the side plate second end. The side plate width is substantially equal to the seal width. At least one tooth extends from the inner face and inserted into the seal.

According to another aspect, a muntin clip is provided for securing a muntin between first and second glazing panes sealed together by a seal. The muntin clip comprises a base having an interior face and an opposed exterior face. The interior and exterior faces extend between a first end positionable towards the first glazing pane and a second end positionable towards the second glazing pane. A muntin connector extends from the interior face. The muntin connector comprises a tongue receivable within the muntin bar and frictionally securable therein. A seal connector extends from the exterior face. The seal connector comprises a side plate positionable between the seal and the first glazing pane. The side plate has an inner face positionable to face the seal and an opposed outer face. At least one tooth extends from the inner face. The at least one tooth is insertable into the seal. The base, muntin connector, and seal connector are integrally formed by injection molding of a plastic.

### DRAWINGS

Reference is made in the detailed description to the accompanying drawings, in which:

FIG. 1 is a partial cutaway front view of a window;

FIG. 2 is a cross section taken along line 2-2 in FIG. 1;

FIG. 3 is an exploded perspective view of the muntin, muntin clip, and seal of FIG. 1;

FIG. 4 is a perspective illustration of an alternate muntin clip; and

FIG. 5 is a perspective illustration of another alternate muntin clip.

### DETAILED DESCRIPTION

Various apparatuses or methods will be described below to provide an example of each claimed invention. No example described below limits any claimed invention and any claimed invention may cover processes or apparatuses that are not described below. The claimed inventions are not limited to apparatuses or processes having all of the features of any one apparatus or process described below or to features common to multiple or all of the apparatuses described below. It is possible that an apparatus or process described below is not an example of any claimed invention. Applicant reserves the right to claim such apparatuses or processes in other applications.

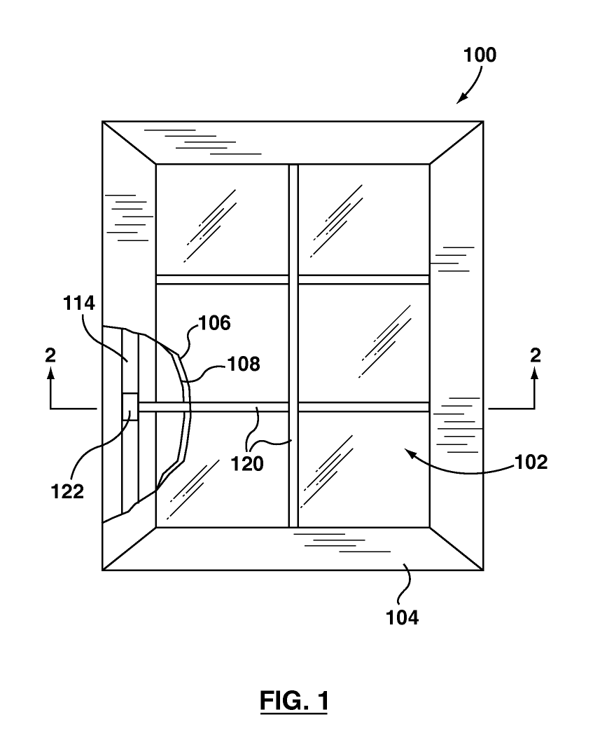

Referring to FIG. 1, an example of a window 100 is shown. The window 100 comprises a glazing unit 102, mounted in a window frame 104. The window frame 104 may be any suitable window frame, and may comprise a glass stop, which secures the glazing unit 102 to the frame.

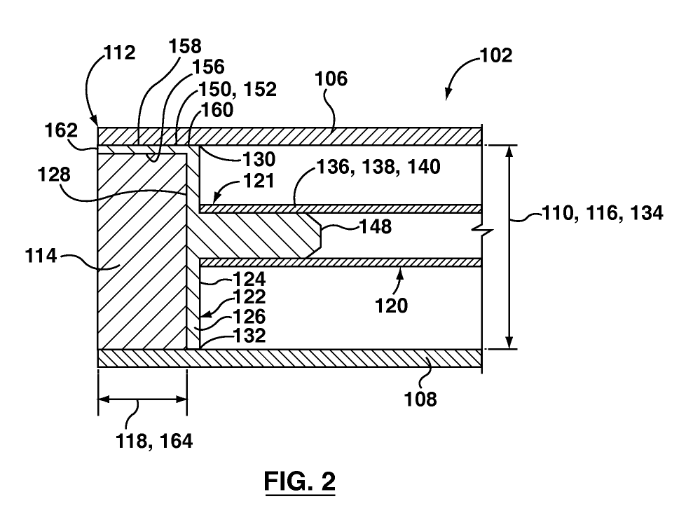

Referring to FIG. 2, the glazing unit 102 comprises a first glazing pane 106 and a second glazing pane 108. The first 106 and second 108 glazing panes are in parallel and opposed relation, and are spaced apart by a glazing gap 110. The first and second glazing panes have a periphery 112, and a seal 114 is disposed between the first and second glazing panes 106, 108 about the periphery 112. The seal 114 may be any suitable seal, and may be a seal only, or a combination seal and spacer. For example, the seal 114 may be, but not limited to, a butyl strip such as a swiggle strip, or an inner foam strip having an outer butyl seal.

Referring still to FIG. 2, the seal 114 has a seal height 116 that is generally equal to the glazing gap 110, and a seal width 118 transverse to the seal height 116.

Referring to FIGS. 1 and 2, the glazing unit 102 further comprises at least one muntin 120 (also known as a muntin bar) between the first glazing pane 106 and the second glazing pane 108. The muntins 120 may be generally hollow extruded lineals. The muntins 120 may be provided in order to create a pattern within the glazing unit 102, to create an aesthetic affect.

Referring to FIG. 2, each muntin 120 has at least one end 121 adjacent the seal 114. A muntin clip 122 is provided for securing the end 121 of the muntin 120 in a fixed position to the seal 114.

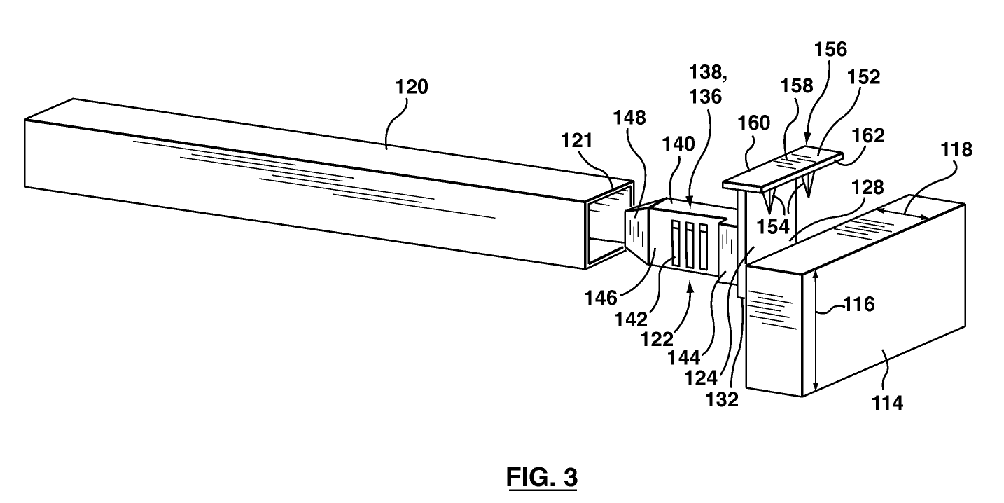

Referring to FIGS. 2 and 3, the muntin clip 122 comprises a base 124, which is a generally planar plate. The base has an interior face 126, facing the muntin 120, and an opposed exterior face 128, facing the seal 114. The interior face 126 and the exterior face 128 of the base 124 extend between a first end 130 (also referred to herein as a base first end 130), which is positioned towards the first glazing pane 106, and an opposed second end 132 (also referred to herein as a base second end 132), which is positioned towards the second glazing pane 108. A height 134 of the base 124 (also referred to as a base height 134) is defined between the first end 130 and the second end 132. With reference to FIG. 2, the height 134 is substantially equal to the glazing gap 110 and the seal height 116, so that the first end 130 contacts the first glazing pane 106, and the second end 132 contacts the second glazing pane 108. In alternate examples, the height of the base may be less than the glazing gap and seal height.

Referring still to FIGS. 2 and 3, a muntin connector 136 extends from the interior face 126 of the base 124. The muntin connector 136 comprises a tongue 138 that is received within the end 121 of the muntin 120 and is frictionally secured therein to secure the muntin clip 122 to the muntin 120. The tongue 138 comprises an arm 140, and a plurality of resiliently flexible wings 142, which extend outwardly from the arm 140 and frictionally engage the muntin 120. The arm 140 includes a foot 144 adjacent and joined to the base, a body portion 146 extending from the foot, and a distal end portion 148 adjacent the body. The foot 144 is sized to frictionally engage the muntin 120. The body portion 146 has a cross sectional area less than the cross sectional area of the foot 144, and does not engage the muntin 120. The wings 142 extend from the body portion 146, are angled towards the foot 144. When the tongue 138 is inserted into the muntin, the wings 142 engage the muntin 120, and flex towards the foot 144. In the example shown, the body portion 146 is generally square or rectangular in cross section, and the wings 142 comprise a first set of wings extending from a first side of the arm 140, and a second set of wings extending from an opposed second side of the arm 140. The distal portion 148 comprises a bevel, to aid in the insertion of the tongue 138 into the muntin 120.

In alternate examples, the muntin connector may be another configuration. For example, the arm and wings may be of any other suitable shape. In a further alternate example, muntin connector may comprise only an arm (i.e. wings may not be provided), and the arm may be sized to frictionally engage the muntin.

The muntin connector 136 is spaced from the first end 130 of the base 124 and the second end 132 of the base 124. In alternate examples, the muntin connector may be adjacent one of the first end and the second end of the base.

Referring still to FIGS. 2 and 3, a seal connector 150 extends from the exterior face 128 of the base 124. The seal connector 150 comprises a side plate 152, and at least one tooth 154 extending from the side plate 152. The side plate 152 is generally planar, extends orthogonally from the first end 130 of the base, and is positioned between the seal 114 and the first glazing pane 106. The side plate 152 has an inner face 156 facing the seal 114, and an opposed outer face 158 facing the first glazing pane 106. The inner face 156 and outer face 158 extend between a first end 160 (also referred to herein as a side plate first end 160) adjacent the base 124, and an opposed second end 162 (also referred to herein as a side plate second end 162). A side plate width 164 is defined between the first end 160 and the second end 162. In the example shown, the side plate width 164 is substantially equal to the seal width 118, so that the second end 162 of the side plate 152 is adjacent the frame 104. In alternate examples, the side plate width may be less than the seal width.

Referring to FIG. 2, the seal connector 150 comprises two teeth 154. In alternate examples, only one tooth, or more than two teeth may be provided. The teeth 154 extend from the inner face 156 of the side plate 152, and are inserted into the seal 114 to connect the muntin clip 122 to the seal 114. In the example shown, the teeth 154 are spaced from the first end 160 of the side plate 152 and the second end 162 of the side plate 152, and are positioned intermediate the first end 160 and the second end 162. In alternate examples, the teeth may be adjacent one of the first end and the second end. The teeth may be of any suitable size and shape that is sufficient to penetrate the seal. In the example shown, the teeth 154 are generally triangular, and have a pointed distal end inserted into the seal 114. In alternate examples, the teeth may be conical, or another suitable shape.

The muntin clip 122 may be integrally formed by injection molding of a plastic. Specifically, the base 124, muntin connector 136, and seal connector 150, including the side plate 152 and the teeth 154, may be integrally formed by injection molding of a plastic.

In use, the glazing unit 102 may be assembled by resting the first glazing pane on the window frame 104, and securing the seal 114 about the periphery of the 112 first glazing pane 106. The muntin connector 136 of the muntin clip 122 may be into the end 121 of the muntin 120, until the interior face 126 of the base 124 abuts the end of the muntin 120. The exterior face 128 of the base 124 may be positioned against the seal 114, and the side plate 152 may be slid towards the seal 114 until the teeth 154 are fully inserted into the seal 114 and the inner face 156 of the side plate 152 abuts the seal 114. The second glazing pane 108 may then be positioned in parallel and opposed relation to the first glazing pane 106, and the periphery 112 of the second glazing pane 108 may be secured to the seal. The assembled glazing unit 102 may then be secured in the window frame by securing the glass stop to the frame.

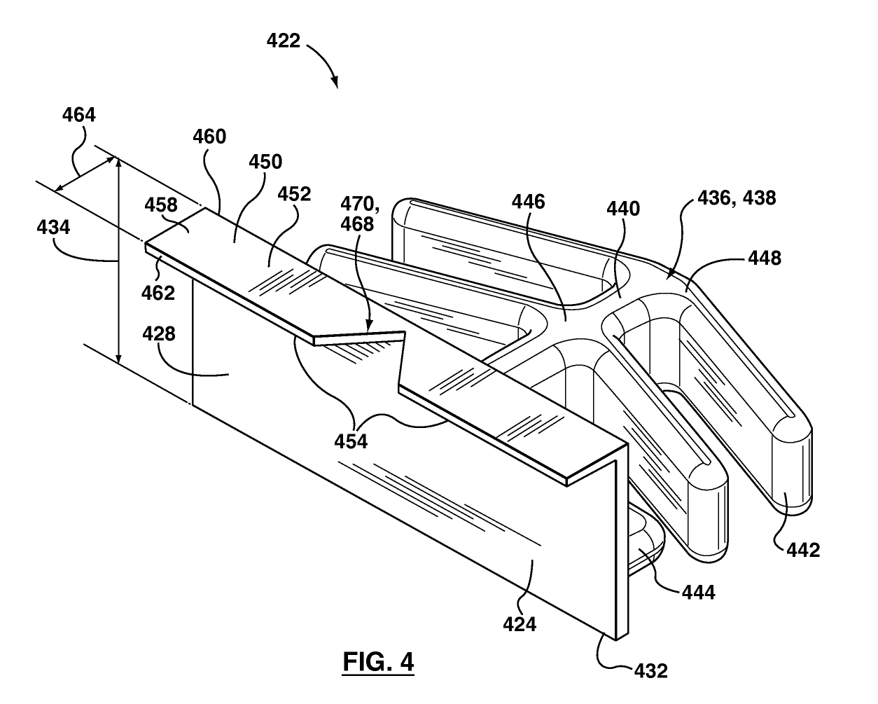

Referring to FIG. 4, where like numerals are used to refer to like features as in FIGS. 1 to 3, with the first digit incremented to 4, another example of a muntin clip 422 is shown. The muntin clip 422 further comprises an indicator 468 for aligning with a mating indicator (now shown) on a window frame, such as window frame 104. This may allow the muntins 120 to be assembled in a predetermined pattern within the window frame. For example, after the muntin connector 436 of the clip 422 is inserted into the muntin, the muntin clip 422 may be connected to the seal at predetermined positions along the frame 104, where the indicator 468 aligns with the mating indicator. In the example shown, the indicator 468 comprises a notch 470, which extends inwardly into the side plate 452 from the second end 462 of the side plate 452. In other examples, the indicator may be a marking. The mating indicator may comprise any suitable feature on the window frame with which the indicator 468 may be aligned. For example, the mating indicator may be a mating marking alignable with the notch 470 or marking, or a projection receivable within the notch 470.

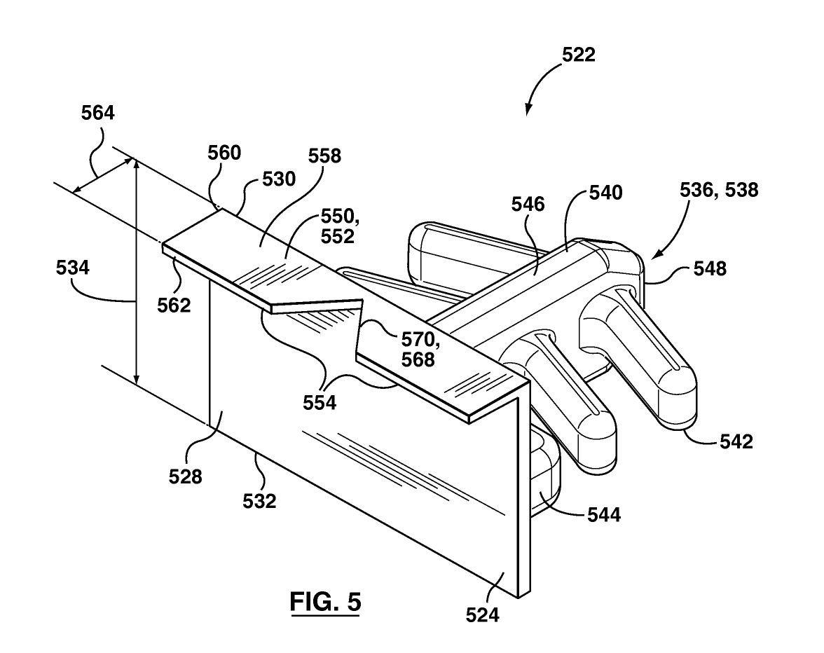

The muntin clip may be sold in various sizes and shapes, in order to be secured to muntins and seals of various sizes and shapes. For example, the muntin connector 436 of FIG. 4 is shaped and sized to be received in a wider and flatter muntin than the muntin 120. Referring to FIG. 5, where like numerals are used to refer to like features as in FIG. 4, with the first digit incremented to 5, another example of a muntin clip 522 is shown. The muntin clip 522 is similar to the muntin clip 422 of FIG. 4, however the muntin connector 536 is sized and shaped to be received in a less wide and less flat muntin than the muntin connector 426.

1. A window glazing unit comprising:
a) a first glazing pane and a second glazing pane in parallel and opposed relation to the first glazing pane, the first and second glazing panes spaced apart by a glazing gap;
b) a seal disposed between the first and second glazing panes about the periphery thereof, the seal having a seal height equal to the glazing gap and a seal width transverse to the seal height;
c) at least one generally hollow muntin between the first glazing pane and the second glazing pane, the muntin having at least one end adjacent the seal; and
d) a muntin clip securing the end of the muntin in a fixed position to the seal, the muntin clip comprising:
i) a base having an interior face and an opposed exterior face, the interior and exterior faces extending between a base first end positioned towards the first glazing pane and a base second end positioned towards the second glazing pane, the base having a base height defined between the base first end and the base second end, the base height substantially equal to the glazing gap;
ii) a muntin connector extending from the interior face, the muntin connector comprising a tongue received within the end of the muntin and frictionally secured therein; and
iii) a seal connector extending from the exterior face, the seal connector comprising a side plate positioned between the seal and the first glazing pane, the side plate having an inner face facing the seal and an opposed outer face, and at least one tooth extending from the inner face and inserted into the seal.

2. The window unit of claim 1, wherein the base, muntin connector and seal connector are integrally formed by injection molding of a plastic.

3. The window glazing unit of claim 1, wherein the inner face and the outer face extend between a side plate first end adjacent the base and an opposed side plate second end and define a side plate width between the side plate first end and the side plate second end, the side plate width substantially equal to the seal width.

4. The window glazing unit of claim 3, wherein the at least one tooth is spaced from the side plate first end and side plate second end.

5. The window glazing unit of claim 3, wherein the side plate second end comprises an indicator for aligning with a mating indicator on a window frame within which the window unit is received.

6. The window glazing unit of claim 5, wherein the indicator is a notch extending inwardly into the side plate from the side plate second end.

7. The window glazing unit of claim 1, wherein the at least one tooth comprises two teeth.

8. The window glazing unit of claim 1, wherein the tongue comprises an arm extending orthogonally from the base, and a plurality of resiliently flexible wings extending outwardly from the arm and frictionally engaging the muntin.

9. The window glazing unit of claim 8, wherein the arm comprises a foot adjacent the base, a body portion extending from the foot, and a distal end portion adjacent the body portion.

10. The window glazing unit of claim 9, wherein the plurality of wings extend from body portion, and are angled towards the foot.

11. The window glazing unit of claim 9, wherein the arm is generally rectangular in transverse cross section, and the plurality of wings comprise a first set of wings extending from a first side of the arm and a second set of wings extending from an opposed second side of the arm.

12. The window glazing unit of claim 9, wherein the distal end portion comprises a bevel.

13. The window glazing unit of claim 9, wherein the foot frictionally engages the muntin.

14. The window glazing unit of claim 13, wherein the body portion has a cross sectional area less than the cross sectional area of the foot.

15. The window glazing unit of claim 1, wherein the tongue is spaced from the first end and the second end of the base.

16. A window glazing unit comprising:
a) a first glazing pane and a second glazing pane in parallel and opposed relation to the first glazing pane, the first and second glazing panes spaced apart by a glazing gap;
b) a seal disposed between the first and second glazing panes about the periphery thereof, the seal having a seal height equal to the glazing gap and a seal width transverse to the seal height;
c) at least one generally hollow muntin between the first glazing pane and the second glazing pane, the muntin having at least one end adjacent the seal; and
d) a muntin clip securing the end of the muntin in a fixed position to the seal, the muntin clip comprising:
i) a base having an interior face and an opposed exterior face, the interior and exterior faces extending between a base first end positioned towards the first glazing pane and a base second end positioned towards the second glazing pane;
ii) a muntin connector extending from the interior face, the muntin connector comprising a tongue received within the end of the muntin and frictionally secured therein; and
iii) a seal connector extending from the exterior face, the seal connector comprising a side plate positioned between the seal and the first glazing pane, the side plate having an inner face facing the seal and an opposed outer face, the inner face and the outer face extending between a side plate first end adjacent the base and an opposed side plate second end and defining a side plate width between the side plate first end and the side plate second end, the side plate width substantially equal to the seal width; and at least one tooth extending from the inner face and inserted into the seal.

17. A muntin clip for securing a muntin between first and second glazing panes sealed together by a seal, the muntin clip comprising:
a) a base having an interior face and an opposed exterior face, the interior and exterior faces extending between a first end positionable towards the first glazing pane and a second end positionable towards the second glazing pane;
b) a muntin connector extending from the interior face, the muntin connector comprising a tongue receivable within the muntin bar and frictionally securable therein;
c) a seal connector extending from the exterior face, the seal connector comprising a side plate positionable between the seal and the first glazing pane, the side plate having an inner face positionable to face the seal and an opposed outer face; and at least one tooth extending from the inner face, the at least one tooth insertable into the seal; wherein the base, muntin connector, and seal connector are integrally formed by injection molding of a plastic.
